(19) United States
(12) Patent Application Publication
(10) Pub. No.: US 2012/0260904 A1
(43) Pub. Date: Oct. 18, 2012

(54) PORTABLE COMPACT FIRE CONTAINMENT RING DEVICE

(76) Inventor: Clint Russell, Lindsay, CA (US)

(21) Appl. No.: 13/086,985

(22) Filed: Apr. 14, 2011

(51) Int. Cl. A47J 37/07; F24C 1/16

(52) U.S. Cl. 126/25 R

(57) ABSTRACT

The present invention is a portable compact fire ring device used to contain a fire in an outdoor fire pit that includes a plurality of metal containment plates with a front facing and a back facing and decorative animal indicia disposed on the front facing or the back facing. There is also a cut-out portion on the containment plates to allow light from the fire that can be seen outside of the device and natural airflow and ventilation of the fire and a plurality of clips utilized to hold the containment plates together forming the device and are utilized to assemble and reassembly the device. The animal indicia can be a deer, a bear or an eagle and the device can be used in combination with a grilling or cooking surface.

### TECHNICAL FIELD & BACKGROUND

The present invention generally relates to a fire containment device. More specifically, the invention is a portable compact fire containment device for outdoor fire pits.

It is an object of the invention to provide a fire containment device for outdoor fire pits that is relatively lightweight, easily portable, and compact and takes-up a relatively small amount of space.

What is really needed is a fire containment device for outdoor fire pits that is relatively lightweight, easily portable, and compact and takes up a relatively small amount of space.

### BRIEF DESCRIPTION OF THE DRAWINGS

The present invention will be described by way of exemplary embodiments, but not limitations, illustrated in the accompanying drawing in which like references denote similar elements, and in which:

FIG. 1A illustrates an overhead front perspective view of a portable compact fire containment device, in accordance with one embodiment of the present invention.

FIG. 1B illustrates an environmental overhead front perspective view of a portable compact fire containment device used in combination with a grilling or cooking surface, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

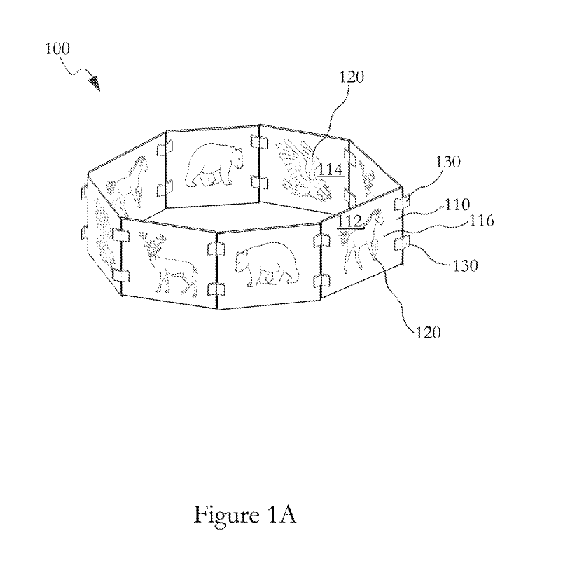

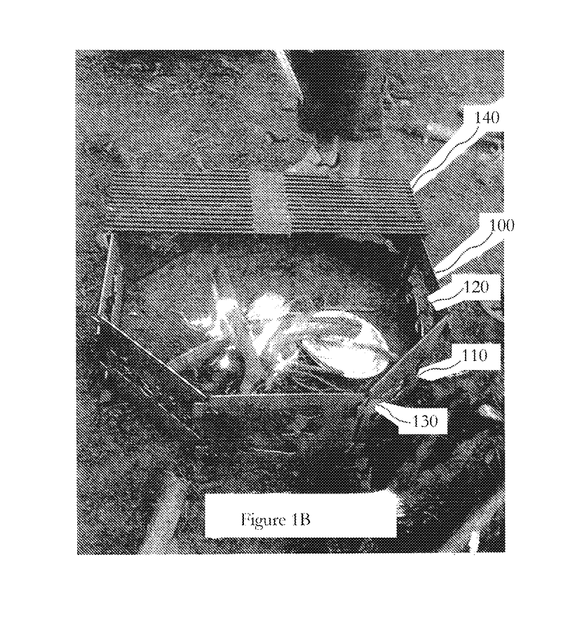

FIG. 1A illustrates an overhead front perspective view of a portable compact fire containment device 100, in accordance with one embodiment of the present invention. The portable compact fire containment device 100 provides a fire containment device for outdoor fire pits that is relatively lightweight, easily portable, and compact and takes up a relatively small amount of space. The portable compact fire containment device 100 can also be used in other suitable fire containment settings as well.

The portable compact fire ring device 100 includes a plurality of containment plates 110 that are made of steel but can be made of other suitable metal or other material. The containment plates 110 have a front facing 112 that faces outward from a contained fire (not shown) and a back facing 114 facing inward towards the contained fire. There are 8 containment plates 110 illustrated in FIGS. 1A and 1B however the portable compact fire ring device 100 can have any suitable number of containment plates 110. Decorative indicia 120 or silhouettes can be disposed on the front facing 112 and/or back facing 114 of the containment plates 110. The decorative indicia 120 can be animal indicia that can include a deer, a bear, an eagle or other suitable animal indicia. The decorative indicia 120 can also be suitable non-animal indicia as well. The containment plates 110 also have a cut-out portion 116 to allow light from a protected fire that can be seen through the cut-out portion 116 of the portable compact fire ring device 100, adding to the natural ambiance. The cut-out portion 116 also allow for natural airflow and ventilation of the fire.

The main purpose of the portable compact fire ring device 100 is to provide users with a containment device for outdoor fire pits. Most parks and outdoor recreational facilities have an insufficient number of fire pits available to campers. This limitation has led many people to purchase conventional camp fire rings that are commonly heavy, bulky and impractical. The portable compact fire ring device 100 illustrated in FIGS. 1A and 1B includes eight ⅛″ steel plates, that when combined measure 30″ in height. The eight containment plates 110 interlock together with a plurality of clips 130 and form an octagonal shape around the surrounded fire to maintain air flow and the fire's size and reduce the possibility of individuals near the surrounded fire from getting burned. The clips 130 can be any type of suitable clip that can assemble and reassemble the containment plates 110 forming the portable compact fire containment device 100.

FIG. 1B illustrates an environmental overhead front perspective view of a portable compact fire containment device 100 used in combination with a grilling or cooking surface, in accordance with one embodiment of the present invention. The features of the portable compact fire containment device 100 illustrated in FIG. 1A are the same as those depicted in FIG. 1B. The grilling or cooking surface 140 can also be utilized in combination with the portable compact fire containment device 100 and its use is straightforward as the grilling or cooking surface is placed anywhere across the portable compact fire containment device 100 for cooking or grilling purposes.

The portable compact fire ring device 100 is relatively compact, easily disassembled and stored in relatively small spaces, allowing for convenient travel and transport. The portable compact fire ring device 100 is in the shape of an octagon with 8 containment plates 110, but can be any multiple sided shape based on the number of containment plates 110 used. The eight containment plates 110 lock together non-evasively, utilizing a plurality of clips 130 as previously described in the FIG. 1A description. The portable compact fire ring device 100 is 30″ in diameter and 11″ tall when assembled. When disassembled and stowed, the portable compact fire ring device 100 is 1.5″×12″ in width and 11″ in height. The containment plates 110 are made out of ⅛″ steel plates, but can be made of any suitable material, thickness and dimensions. The portable compact fire ring device 100 can also be used in combination with a grilling surface, as previously described in FIG. 1B.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A portable compact fire ring device, comprising:
a plurality of containment plates with a front facing and a back facing;
decorative indicia disposed on said front facing and said back facing;
a cut-out portion of said containment plates; and
a plurality of clips utilized to hold said containment plates together forming said portable compact fire ring device.

2. The device according to claim 1, wherein 8 said containment plates are attached together to form said device.

3. The device according to claim 2, wherein said containment plates are made of steel.

4. The device according to claim 3, wherein said containment plates are ⅛^{th}″ thick.

5. The device according to claim 1, wherein said decorative indicia is animal indicia.

6. The device according to claim 5, wherein said animal indicia includes a deer, a bear or an eagle.

7. The device according to claim 1, wherein said cut-out portion allows light from a surrounded fire that can be seen outside of said device.

8. The device according to claim 7, wherein said cut-out portion allows natural airflow and ventilation of said surrounded fire.

9. The device according to claim 1, wherein said clips are utilized to assemble and reassembly said device.

10. The device according to claim 1, wherein said device is used to contain said surrounded fire in an outdoor fire pit.

11. The device according to claim 1, wherein said device is used in combination with a grilling or cooking surface.

12. A portable compact fire ring device used to contain a fire in an outdoor fire pit, comprising:
a plurality of steel containment plates with a front facing and a back facing;
decorative animal indicia disposed on said front facing and said back facing;
a cut-out portion of said containment plates to allow light from said fire that can be seen outside of said device and natural airflow and ventilation of said fire; and
a plurality of clips utilized to hold said containment plates together forming said portable compact fire ring device and said clips are utilized to assemble and reassembly said device.

13. The device according to claim 12, wherein 8 said containment plates are attached together to form said device.

14. The device according to claim 13, wherein said containment plates are ⅛^{th}″ thick.

15. The device according to claim 12, wherein said animal indicia includes a deer, a bear or an eagle.

16. The device according to claim 12, wherein said device is used in combination with a grilling or cooking surface.

17. A portable compact fire ring device used to contain a fire in an outdoor fire pit, comprising:
eight metal containment plates with a front facing and a back facing;
decorative animal indicia disposed on said front facing and said back facing;
a cut-out portion of said containment plates to allow light from said fire that can be seen outside of said device and natural airflow and ventilation of said fire; and
a plurality of clips utilized to hold said containment plates together forming said device and are utilized to assemble and reassembly said device.

18. The device according to claim 17, wherein said containment plates are ⅛^{th}″ thick.

19. The device according to claim 17, wherein said animal indicia includes a deer, a bear or an eagle.

20. The device according to claim 17, wherein said device is used in combination with a grilling or cooking surface.
